(19) United States
(12) Patent Application Publication
(10) Pub. No.: US 2015/0079826 A1
(43) Pub. Date: Mar. 19, 2015

(54) LEVER-TYPE CONNECTOR

(71) Applicant: Yazaki Corporation, Tokyo (JP)

(72) Inventor: Jun KAMIYA, Toyota-shi (JP)

(73) Assignee: Yazaki Corporation, Tokyo (JP)

(21) Appl. No.: 14/549,081

(22) Filed: Nov. 20, 2014

Related U.S. Application Data
(63) Continuation of application No. PCT/JP2013/064139, filed on May 15, 2013.

(30) Foreign Application Priority Data
May 23, 2012 (JP) 2012-117826

(51) Int. Cl. H01R 13/629

(52) U.S. Cl. CPC H01R 13/62955
USPC 439/157

(57) ABSTRACT

Lever main bodies have first boss introduction grooves guiding first lever engagement shaft portions on a first connector housing to a first mounting initiating position P1 when a fitting control lever is mounted on the first connector housing, first fitting control grooves along which the first lever engagement shaft portions situated in the first mounting initiating position P1 when the fitting control lever is pulled out, second boss introduction grooves which guide second lever engagement shaft portions on a second connector housing to a second mounting initiating position P2 when the connector housings are registered with their fitting initiating position and second fitting control grooves along which the second lever engagement shaft portions situated in the second mounting initiating position P2 slide when the fitting control lever is pulled out of the second connector housing.

### CROSS REFERENCE TO RELATED APPLICATIONS

This application is a continuation of PCT application No. PCT/JP2013/064139, which was filed on May 15, 2013 based on Japanese patent application (patent application 2012-117826) filed on May 23, 2012, whose contents are incorporated herein by reference. Also, all the references cited herein are incorporated as a whole.

### BACKGROUND OF THE INVENTION

1. Technical Field

The present invention relates to a lever-type connector.

2. Background Art

FIG. 12 shows an example of a conventional lever-type connector.

This lever-type connector 100 is disclosed in Japanese Patent No. 3442661, and includes a first connector housing 110, a second connector housing 120 which is fitted and connected together with the first connector housing 110, and a fitting control lever 130 which is mounted rotatably on the first connector housing 110.

The second connector housing 120 has an outer angularly tubular wall portion (a hood portion) 121 into which the first connector housing 110 is inserted.

The fitting control lever 130 is mounted rotatably on boss portions 111 which are provided on outer surfaces of the first connector housing 110 so as to project therefrom as a lever member which reduces operation forces with which the first connector housing 110 and the second connector housing 120 are fitted together and are released from such a fitted state.

As shown in FIG. 12, the fitting control lever 130 includes a pair of lever main bodies 131 which are oppositely disposed so as to hold a pair of outer surfaces of the first connector housing 110 therebetween, a connecting member 132 which connects together ends of the pair of lever main bodies 131, rotation fulcrum or pivot holes 133 which are formed individually in the lever main bodies 131 so as to be brought into rotational engagement with the boss portions 111 which are provided on the outer surfaces of the first connector housing 110, projecting portions 134 functioning as action points which are brought into engagement with lever locking holes 122 which are formed in outer surfaces of the outer angularly tubular wall portion 121 in an initial fitting stage of the first connector housing 110 and the second connector housing 120 in which both the connector housings are registered with their fitting initiating position.

In the case of the depicted example, the connecting member 132 doubles as a force application point to which a force is applied when the lever main bodies 131 are rotated about the boss portions 111.

In the lever-type connector 100 of Japanese Patent No. 3442661, the first connector housing 110 and the second connector housing 120 are fitted and connected together according to the following procedure.

Firstly, as shown in the figure, the fitting control lever 130 is mounted rotatably on the first connector housing 110. Following this, as indicated by an arrow X1 in FIG. 12, a front end portion of the first connector housing 110 is inserted into an interior of the outer angularly tubular wall portion 121 of the second connector housing 120, and the first connector housing 110 and the second connector housing 120 are registered with their fitting initiating position. Then, the projecting portions 134, functioning as action points, of the fitting control lever 130 are brought into engagement with the lever locking holes 122 in the second connector housing 120.

Following this, the connecting member 132 of the fitting control lever 130 is pressed downwards so as to rotate the fitting control lever 130 as indicated by an arrow R1 in the figure. The rotating operation of the fitting control lever 130 draws the second connector housing 120 towards the first connector housing 110, whereby both the connector housings are fitted together completely.

When the connector housings which are fitted together so are released from the fitted state, the connecting member 132 is rotated in an opposite direction to the direction indicated by the arrow R1 in the figure, whereby the connector housings are separated from each other.

In addition, Patent Literature, JP-A-7-135046, discloses a lever-type connector having a configuration in which a first connector housing and a second connector housing which are registered with their fitting initiating position are fitted and connected together by means of a fitting control lever (which is called a slide 14 in JP-A-7-135046) which is inserted to be mounted in the first connector housing.

The fitting control lever of JP-A-7-135046 is inserted into the first connector housing in a direction which is at right angles to a direction in which both the connector housings are fitted together. In this fitting control lever, guide grooves are formed in an inclined fashion so that lever engagement shaft portions which are provided on outer surfaces of the second connector housing so as to project therefrom can slide therealong. Then, both the connector housings are fitted to each other by pulling in the lever engagement shaft portions along the inclined guide grooves in the direction in which the connector housings are fitted together.

### SUMMARY

In the case of the lever-type connectors of Patent Literatures, Japanese Patent No. 3442661 and JP-A-7-135046, however, the fitting control lever cannot be removed from the first connector housing in such a state that both the connector housings are fitted and connected together.

Because of this, in the case of the lever-type connectors of Japanese Patent No. 3442661, the weight of the fitting control lever is kept additionally applied to the connector even after both the connector housings are completely fitted and connected together, resulting in a factor which calls for an increase in weight of the connector.

In addition, in the case of the lever-type connectors of Patent Literatures, Japanese Patent No. 3442661 and JP-A-7-135046, the connector has to be accompanied by the fitting control lever in any case, leading to a problem that the production costs are increased due to the increase in the number of constituent parts involved.

Then, the invention has been made to solve the problems inherent in the conventional lever-type connectors, and an object of the invention is to provide a lever-type connector which can realize a reduction in production cost and weight in use by reducing the number of constituent parts involved.

The object of the invention is attained by the following configurations.

(1) A lever-type connector comprising:

a first connector housing:

a second connector housing which is fitted and connected to the first connector housing; and

a fitting control lever which is mounted on the first connector housing as a fitting assist member; wherein

the first connector housing comprises:

a housing main body including a plurality of terminal insertion holes; and

a pair of first lever engagement shaft portions which are provided individually on a pair of outer side walls of the housing main body so as to project therefrom; wherein

the second connector housing comprises:

an outer angularly tubular wall portion which fits on an outer circumference of the first connector housing;

a pair of second lever engagement shaft portions that are provided individually on a pair of inner side surfaces of the outer angularly tubular wall portion which oppositely face the pair of outer side walls of the first connector housing so as to project therefrom and which are positioned a predetermined spacing distance opposite to the first lever engagement shaft portions in a direction in which both the connector housings are fitted together when the first connector housing and the second connector housing are registered with their fitting initiating position; and

guide ribs which are provided individually on the pair of inner side surfaces so as to extend at a first inclination angle which is set to a predetermined inclination angle with respect to the direction in which both the connector housings are fitted together; wherein

the fitting control lever comprises:

a pair of lever main bodies which are disposed opposite to each other so as to be inserted into gaps defined between the pair of outer side walls of the first connector housing and the pair of inner surfaces of the outer angularly tubular wall portion;

first boss introduction grooves that are formed individually on inner surfaces of the pair of main bodies along the direction in which both the connector housings are fitted together and which guide the first lever engagement shaft portions to a first mounting initiating position when the pair of lever main bodies are placed on the pair of outer side walls;

first fitting control grooves along which the first lever engagement shaft portions which are situated in the first mounting initiating position slide when the fitting control lever which is mounted on the first connector housing is pulled out of the first connector housing at the first inclination angle and which are formed so as to communicate with the first boss introduction grooves at a second inclination angle at which portions of the first fitting control grooves which are far away from the first mounting initiating position intersect extensions of the guide ribs which extend at the first inclination angle;

second boss introduction grooves that are formed individually on outer surfaces of the pair of lever main bodies along the direction in which both the connector housings are fitted together and which guide the second lever engagement shaft portions to a second mounting initiating position when the first connector housing on which the fitting control lever is mounted in such a state that the first lever engagement shaft portions are situated in the first mounting initiating position and the second connector housing are registered with their fitting initiating position; and

second fitting control grooves along which the second lever engagement shaft portions which are situated in the second mounting initiating position slide when the fitting control lever which is mounted in such a state that the second lever engagement shaft portions are situated in the second mounting initiating position is pulled out of the second connector housing at the first inclination angle and which are formed so as to communicate with the second boss introduction grooves at the first inclination angle; and wherein

both the connector housings are fitted and connected together, by pulling out the fitting control lever from both the connector housings in such a state that the first connector housing and the second connector housing are registered with their fitting initiating position, the first lever engagement shaft portions are situated in the first mounting initiating position, and the second lever engagement shaft portions are situated in the second mounting initiating position.

The fitting control lever may be adapted to reduce operation forces with which the first connector housing and the second connector housing are fitted together and are released from such a fitted state.

The first connector housing may further comprise a locking securing portion that is provided on a side surface of the housing main body and which is brought into engagement with the second connector housing when the first connector housing and the second connector housing are fitted and connected together completely to thereby lock both the connector housings in a connected state.

The second connector housing may further comprise a securement ensuring portion which is brought into engagement with the locking securing portion when the first connector housing and the second connector housings are fitted and connected together completely to thereby lock both the connector housings in a connected state

The fitting control lever may further comprise temporary securing pieces which are brought into engagement with the guide ribs when the second lever engagement shaft portions are situated in the second mounting initiating position to thereby restrain the fitting control lever from moving along the direction in which both the connector housings are fitted together to be disengaged from the second connector housing.

(2) The lever-type connector according to the above (1), wherein

the first lever engagement shaft portions and the second lever engagement shaft portions are disposed so as to be aligned with each other in a direction which is at right angles to the direction in which both the connector housings are fitted together.

(3) The lever-type connector according to the above (1), wherein

the first connector housing comprises temporary lever securing portions which are positions away from the first lever engagement shaft portions in the direction which is at right angles to the direction in which both the connector housings are fitted together, and wherein

the fitting control lever comprises positioning portions which are brought into engagement with the temporary lever securing portions when the first lever engagement shaft portions which fit in the first boss introduction grooves reach the first mounting initiating position.

(4) The lever-type connector according to the above (1), wherein

the first fitting control grooves and the second fitting control grooves are formed into a curvilinear configuration so that a moving locus of the fitting control lever produced when the fitting control lever is pulled out becomes curvilinear.

According to the configuration described under (1) above, as an operating procedure of fitting and connecting the connector housings together, firstly, the fitting control lever is mounted on the first connector housing so that the pair of first lever engagement shaft portions on the first connector housing fit in the pair of first boss introduction grooves on the fitting control lever, and the fitting control lever is fixed to the first connector housing in a temporarily secured state in which the first lever engagement shaft portions reach the first mounting initiating position.

Following this, the first connector housing to which the fitting control lever is temporarily secured is inserted into the outer angularly tubular wall portion of the second connector housing along the direction in which both the connector housings are fitted together, whereby the first connector housing and the second connector housing are registered with their fitting initiating position.

With the first connector housing and the second connector housing registered with their fitting initiating position, the pair of second lever engagement shaft portions of the second connector housing fit in the second boss introduction grooves of the fitting control lever and reach the second mounting initiating position on the second boss introduction grooves.

In addition, with the first connector housing and the second connector housing registered with their fitting initiating position, the temporary securing pieces provided on the fitting control lever are in engagement with the guide ribs on the second connector housing. Then, by the engagement of the temporary securing pieces with the guide ribs, the fitting control lever is restrained from moving along the direction in which both the connector housings are fitted together to be disengaged from the second connector housing, whereby the fitting control lever is temporarily secured to the first connector housing and the second connector housing.

Following this, the fitting control lever is pulled out of the first connector housing and the second connector housing which are registered with their fitting initiating position. When the fitting control lever is pulled out so, the first lever engagement shaft portions which are situated in the first mounting initiating position slide on the first fitting control grooves which are formed so as to communicate with the first boss introduction grooves. Additionally, the second lever engagement shaft portions which are situated in the second mounting initiating position slide on the second fitting control grooves which are formed so as to communicate with the second boss introduction grooves.

Then, since the inclination angles of the first and second fitting control grooves set so that the portions of the first fitting control grooves on the fitting control lever which are away from the first mounting initiating position intersect the second fitting control grooves, as the fitting control lever is pulled out progressively, the first lever engagement shaft portions on the first fitting control grooves are moved towards the second lever engagement shaft portions on the second fitting control grooves, whereby the connector housings are fitted deeply together.

Then, when the fitting control lever is pulled out of both the connector housings, the connector housings are fitted and connected together completely, and at the same time, the fitting control lever is disengaged from both the connector housings. Additionally, when both the connector housings are fitted and connected together completely, a locking securing portion of the first connector housing is brought into engagement with a securement ensuring portion of the second connector housing, whereby both the connector housings are locked in the connected state.

Namely, according to the configuration described under (1) above, the connector housings are configured so as to be fitted deeply together by pulling out the fitting control lever. When the connector housings are fitted and connected together completely, the fitting control lever has been pulled out of both the connector housings and is then disengaged therefrom. Because of this, the weight of the fitting control lever is not applied to the connector when in use, thereby making it possible to realize a reduction in weight of the connector when in use.

Additionally, the fitting control lever that is disengaged from the connector housings can be used to build up another lever-type connector. Because of this, the first connector housing and the second connector housing excluding the fitting control lever only have to be prepared as a set of parts for a normal lever-type connector, thereby making it possible to realize a reduction in the number of parts involved.

According to the configuration described under (2) above, the first boss introduction grooves and the second boss introduction grooves on the fitting control lever are formed on the front and rear sides of the lever main bodies so as to be aligned with each other in the direction which is at right angles to the direction in which both the connector housings are fitted together. Therefore, the first boss introduction grooves and the second boss introduction grooves can be designed to be disposed the same spacing distance from the same reference plane, thereby making it possible to facilitate the disposition design of the first boss introduction grooves and the second boss introduction grooves.

According to the configuration described under (3) above, when the fitting control lever is mounted on the first connector housing, the first lever engagement shaft portions on the first connector housing are positioned in the first mounting initiating position by the first boss introduction grooves. Further, the positioning portions on the fitting control lever are brought into abutment with the temporary lever securing portions of the first connector housing, whereby the fitting control lever is temporarily fixed to the first connector housing.

In other words, the fitting control lever mounted on the first connector housing is positioned at such two locations as the first boss introduction grooves and the positioning portions, and therefore, it is possible to ensure the stable positioning of the fitting control lever with respect to the first connector housing, whereby the loosening of the fitting control lever relative to the first connector housing is made difficult to occur. Because of this, the inadvertent displacement of the fitting control lever can be prevented which would otherwise occur when the first connector housing and the second connector housing are registered with their fitting initiating position, thereby making it possible to facilitate the registration of the first and second connector housings with their fitting initiating position.

Consequently, the fitting and connecting of the first and second connector housings can be facilitated.

According to the configuration described under (4) above, when the fitting control lever is pulled out of the connector housings, the displacement of the fitting control lever in a direction which is at right angles to the direction in which both the connector housings are fitted together can be reduced, compared with the case where the moving locus of the fitting control lever is rectilinear. Because of this, the working space necessary for the pulling out operation of the fitting control lever can be reduced, thereby making it possible to realize a highly compact mounting of the lever-type connector.

According to the lever-type connector of the invention, the fitting control lever is disengaged from the connector housings after the connector housings are fitted and connected completely, and therefore, it is possible to realize a reduction in weight of the connector when in use.

In addition, the fitting control lever that is disengaged from the connector housings can also be used to build up another lever-type connector. Therefore, the first connector housing and the second connector housing excluding the fitting control lever only have to be prepared as a set of parts for a normal lever-type connector, thereby making it possible to realize a reduction in the number of parts involved.

Thus, the invention has been described briefly. Further, the details of the invention will be made clearer by perusing the following modes for carrying out the invention (hereinafter, referred to as “embodiments”) by reference to accompanying drawings.

### BRIEF DESCRIPTION OF THE DRAWINGS

FIG. 1 is an exploded perspective view of a lever-type connector according to a first embodiment of the invention.

FIG. 2 is a view of a second connector housing shown in FIG. 1 as viewed in a direction indicated by an arrow A.

FIG. 3 is a sectional view of the second connector housing taken along a line B-B in FIG. 2.

FIG. 4 is a side view of a fitting control lever shown in FIG. 1.

FIG. 5 is a view of the fitting control lever as viewed in a direction indicated by an arrow C in FIG. 4.

FIG. 6 is a sectional view of the fitting control lever taken along a line D-D in FIG. 5.

FIG. 7 is a side view showing a state occurring before a first connector housing on which the fitting control lever is temporarily locked is inserted into the second connector housing.

FIG. 8 is a side view showing a state in which the first connector housing and the second connector housing are registered with their fitting initiating position.

FIG. 9 is a side view showing a state in which the fitting control lever is being pulled out of both the connector housings which are registered with their fitting initiating position.

FIG. 10 is a side view showing a state in which with the fitting control lever pulled out of both the connector housings, the connector housings are fitted and connected together completely.

FIG. 11 is a comparison diagram between a lever-type connector according to a second embodiment which is improved so that a space necessary for the fitting control lever to be pulled out is reduced and the lever-type connector according to the first embodiment.

FIG. 12 is an exploded perspective view of a conventional lever-type connector.

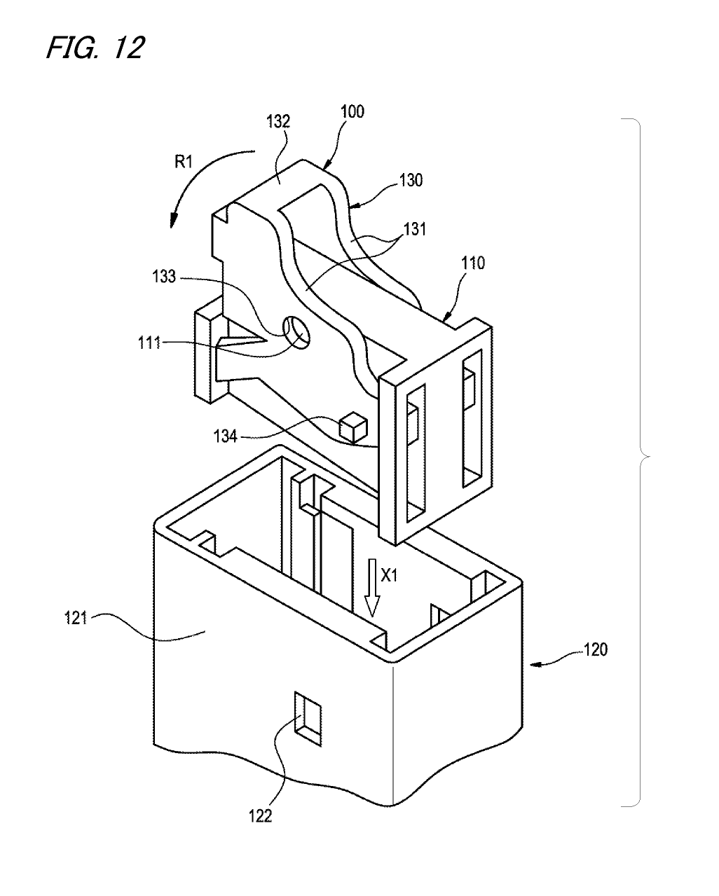

### DETAILED DESCRIPTION OF EMBODIMENTS

Hereinafter, preferred embodiments of lever-type connectors according to the invention will be described in detail by reference to the drawings.

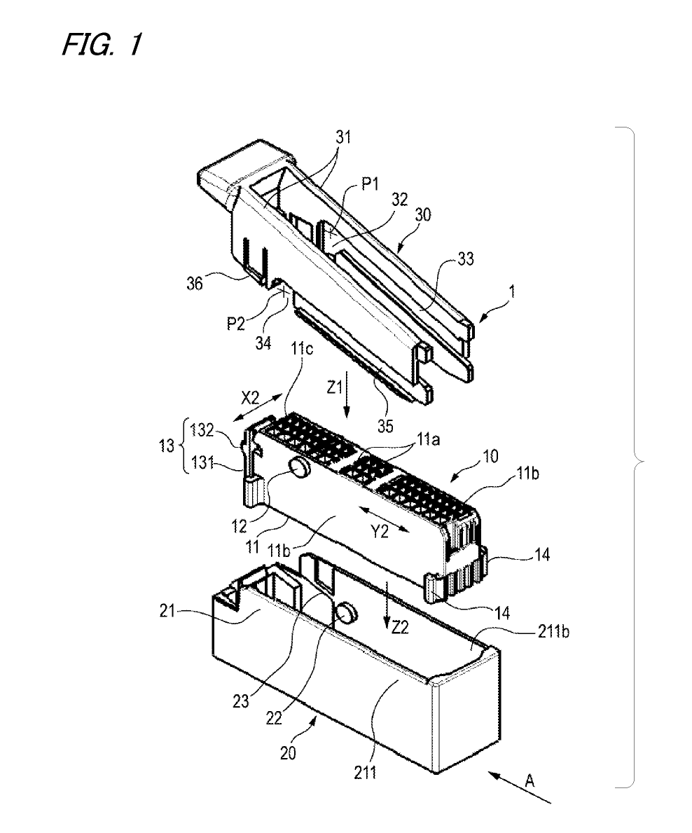

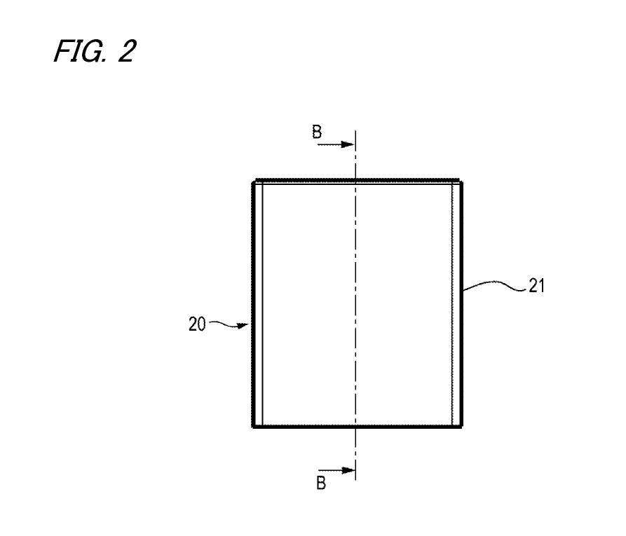

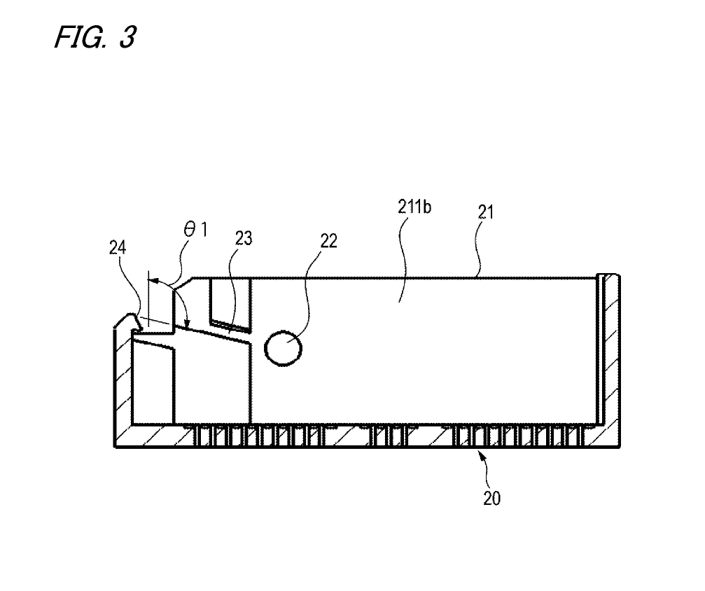

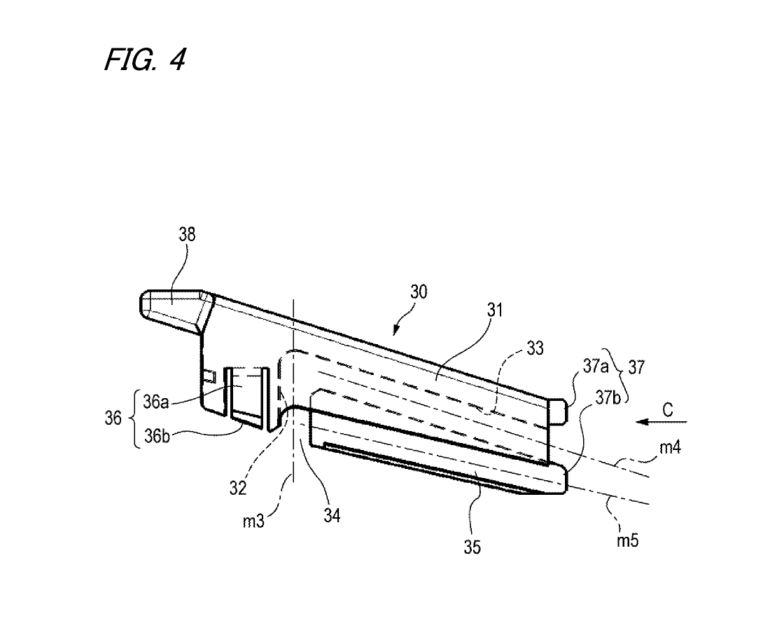

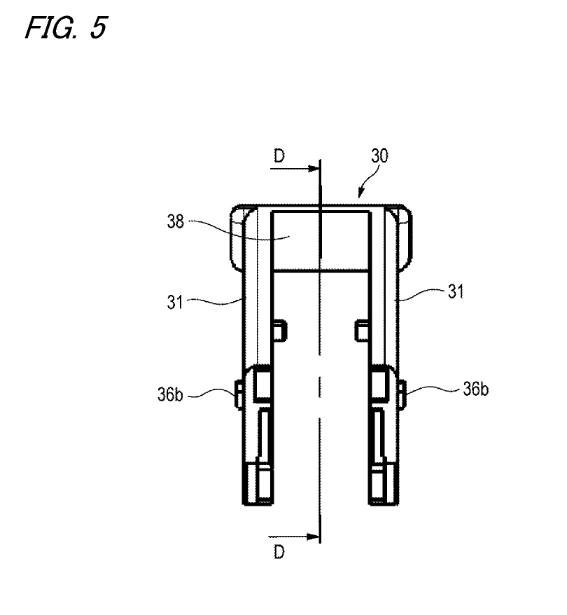

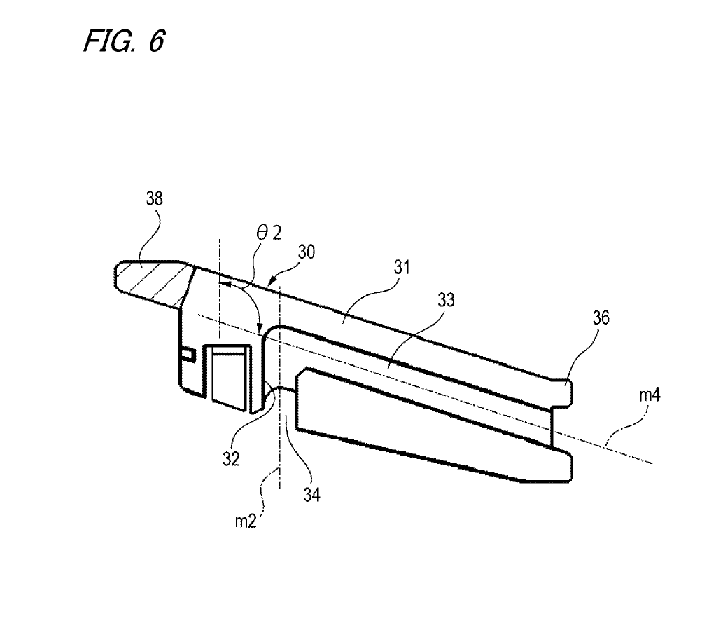

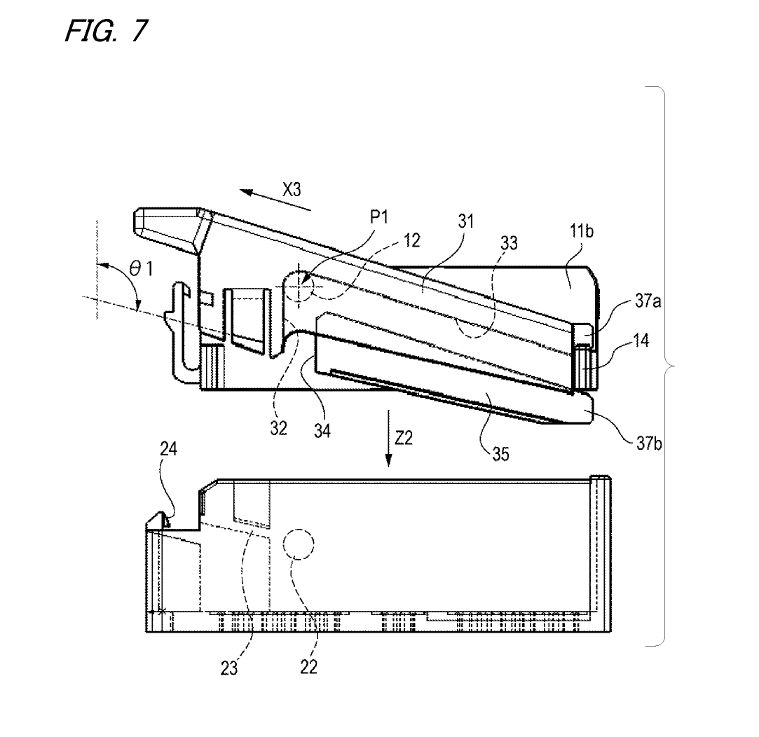

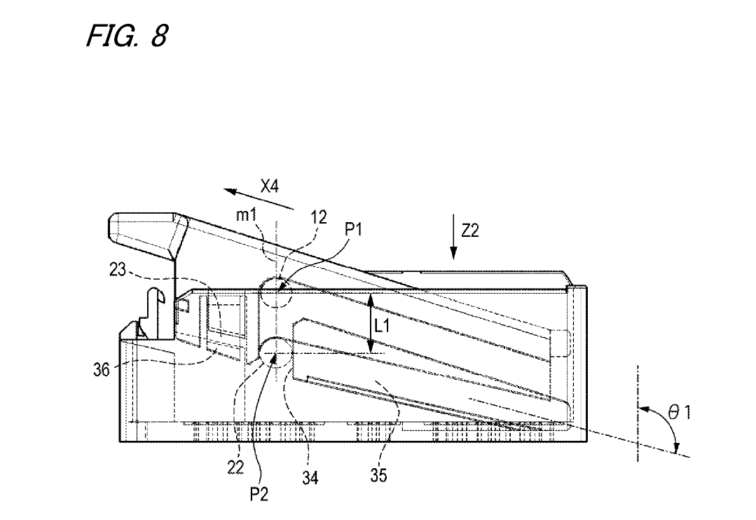

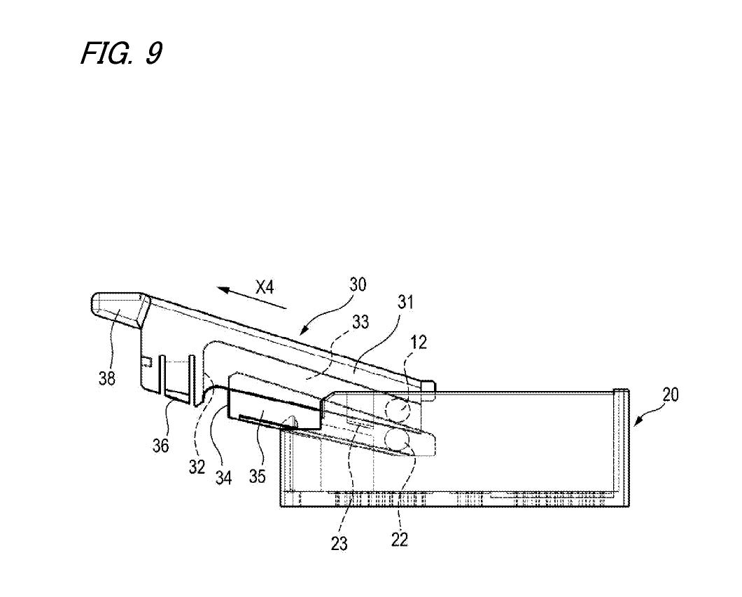

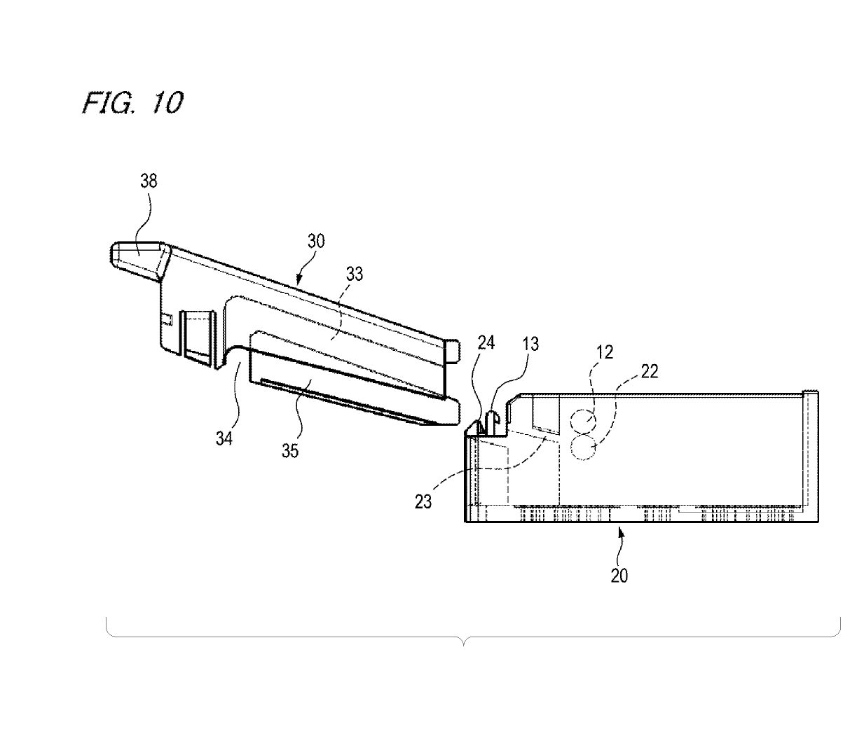

FIGS. 1 to 10 show a lever-type connector according to a first embodiment of the invention. FIG. 1 is an exploded perspective view of a lever-type connector according to a first embodiment of the invention, FIG. 2 is a view of a second connector housing shown in FIG. 1 as viewed in a direction indicated by an arrow A, FIG. 3 is a sectional view of the second connector housing taken along a line B-B in FIG. 2, FIG. 4 is a side view of a fitting control lever shown in FIG. 1, FIG. 5 is a view of the fitting control lever as viewed in a direction indicated by an arrow C in FIG. 4, FIG. 6 is a sectional view of the fitting control lever taken along a line D-D in FIG. 5, FIG. 7 is a side view showing a state occurring before a first connector housing on which the fitting control lever is temporarily locked is inserted into the second connector housing, FIG. 8 is a side view showing a state in which the first connector housing and the second connector housing are registered with their fitting initiating position, FIG. 9 is a side view showing a state in which the fitting control lever is being pulled out of both the connector housings which are registered with their fitting initiating position, and FIG. 10 is a side view showing a state in which with the fitting control lever pulled out of both the connector housings, the connector housings are fitted and connected together completely.

As shown in FIG. 1, the lever-type connector 1 of the first embodiment includes a first connector housing 10, a second connector housing 20 which is fitted and connected together with the first connector housing 10, and a fitting control lever 30. It should be noted that an arrow Z1 shown in FIG. 1 denotes a direction in which the fitting control lever 30 is placed on to the first connector housing 10. Additionally, an arrow Z2 shown in the same figure denotes a direction in which the first connector housing 10 is fitted into the second connector housing 20 for installation therein.

As shown in FIG. 1, the first connector housing 10 includes a housing main body 11 which includes, in turn, a plurality of terminal insertion holes 11a, a pair of first lever engagement shaft portions (boss portions) 12, a locking securing portion 13, and a pair of temporary lever securing portions 14.

The housing main body 11 has a rectangular parallelepiped shape as an external shape.

The pair of first lever engagement shaft portions 12 are cylindrical shafts which are provided individually on a pair of outer side walls 11b of the housing main body 11 so as to project therefrom. The pair of outer side walls 11b are side walls which stand opposite to each other in a direction indicated by an arrow X2 in FIG. 1.

As shown in FIG. 1, the locking securing portion 13 is provided on a side surface 11c of the housing main body 11. The side surface 11c is a surface of an outer side wall which differs from the pair of outer side walls 11b described above.

As shown in FIG. 1, the locking securing portion 13 of this embodiment includes an elastic piece 131 which rises from a front end side of the side surface 11c and extends towards a rear end side of the side surface 11c, and a securing projection 132 which is provided on the elastic piece 131 so as to project therefrom. The locking securing portion 13 is brought into engagement with the second connector housing 20 when the first connector housing 10 and the second connector housing 20 are fitted and connected together completely to thereby lock both the connector housings in a fittingly connected state.

The pair of temporary lever securing portions 14 are projecting portions which are provided on the pair of outer side walls 11b. The respective temporary lever securing portion 14 are provided on the pair of outer side walls 11b in positions which are spaced away from the first lever engagement shaft portions 12 in a direction which is at right angles (a direction indicated by an arrow Y2 in FIG. 1) to a direction in which the connector housings are fitted to each other (a direction indicated by an arrow Z2 in FIG. 1).

As shown in FIGS. 1 to 3, the second connector housing 20 includes an outer angularly tubular wall portion (a hood portion) 21, a pair of second lever engagement shaft portions (boss portions) 22, guide ribs 23, and a securement ensuring portion 24.

The outer angularly tubular wall portion 21 is an angularly tubular portion that is formed on a front end side of the second connector housing 20 and which fits on an outer circumference of the first connector housing 10. In this outer angularly tubular wall portion 21, inner side surfaces 211b, which are inner surfaces of a pair of side walls 211 which stand opposite to each other, are surfaces which stand opposite to the pair of outer side walls 11b of the first connector housing 10.

The pair of second lever engagement shaft portions 22 are cylindrical shafts which are provided individually on the pair of inner side surfaces 211b of the outer angularly tubular wall portion 21. The pair of second lever engagement shaft portions 22 are positioned a predetermined spacing distance L1 (refer to FIG. 8) opposite to the first lever engagement shaft portions 12 in the direction in which both the connector housings are fitted to each other (the direction indicated by the arrow Z2 in FIG. 8) when the first connector housing 10 and the second connector housing 20 are registered with their fitting initiating position as shown in FIG. 8.

In the case of this embodiment, the first lever engagement shaft portions 12 and the second lever engagement shaft portions 22 are disposed so as to be aligned with each other in a direction which is at right angles to the direction in which both the connector housings are fitted to each other. Consequently, as shown in FIG. 8, the first lever engagement shaft portions 12 and the second lever engagement shaft portions 22 are aligned on a single straight line m1 which extends in the direction in which both the connector housings are fitted together.

As shown in FIG. 3, the guide ribs 23 are provided individually on the pair of inner side surfaces 211b so as to extend at a first inclination angle θ1 with respect to the direction in which both the connector housings are fitted together (the direction indicated by the arrow Z2 in FIG. 1).

The securement ensuring portion 24 is brought into engagement with the locking securing portion 13 of the first connector housing 10 so as to lock both the connector housings in the connected state when the first connector housing 10 and the second connector housing 20 are fitted and connected together completely as shown in FIG. 10.

The fitting control lever 30 is mounted on the first connector housing 10 as a fitting assist member which reduces operation forces with which the first connector housing 10 and the second connector housing 20 are fitted together or are released from the fitted state.

As shown in FIGS. 4 to 6, the fitting control lever 30 includes a pair of lever main bodies 31, first boss introduction grooves 32, first fitting control grooves 33, second boss introduction grooves 34, second fitting control grooves 35, temporary securing pieces 36, and positioning portions 37.

The pair of lever main bodies 31 are thick plate-like members which are disposed opposite to each other so as to be inserted into corresponding gaps defined individually between the pair of outer side walls 11b of the first connector housing 10 and the pair of inner side walls 211b of the outer angularly tubular wall portion 21 of the second connector housing 20. As shown in FIGS. 4 to 6, proximal ends of the pair of lever main bodies 31 are connected together by a handle portion 38. The handle portion 38 is a portion to be gripped on when the fitting control lever 30 is pulled out of the connector housings.

As shown in FIG. 6, the first boss introduction groove 32 is formed on an inner surface of each of the pair of lever main bodies 31 so as to extend along a straight line m2. The straight line m2 shown in FIG. 6 is a straight line which extends in the direction in which both the connector housing are fitted together. Namely, the first boss introduction groove 32 is formed along the direction in which both the connector housings are fitted together.

The first boss introduction grooves 32 guide the first lever engagement shafts 12 to a first mounting initiating position P1 when the pair of lever main bodies 31 are placed on the pair of outer side walls 11b of the first connector housing 10 as shown in FIG. 7. The first mounting initiating position P1 is a terminating end of the first boss introduction grooves 32 where the first lever engagement shafts 12 are stopped.

As shown in FIG. 6, the first fitting control groove 33 is formed on the inner surface of each of the pair of lever main bodies 31 so as to extend along a straight line m4. Additionally, this first fitting control groove 33 is formed so as to communicate with the terminating end of the first boss introduction groove 32.

As shown in FIG. 6, the straight line m4 is a straight line which extends at a second inclination angle θ2 with respect to the direction in which both the connector housings are fitted together (the direction indicated by the arrow Z2 in FIG. 1). The second inclination angle θ2 is set to an angle which is larger than the first inclination angle θ1. In other words, the second inclination angle θ2 is an inclination angle at which an end portion (a right end portion in FIG. 4) of the straight line m4 which is spaced far away from the first mounting initiating position P1 intersects an extension of the guide rib 23 which is inclined at the first inclination angle θ1. Consequently, the straight line m4 intersects the extension of the guide rib 23 which is inclined at the first inclination angle θ1 at the end portion thereof which is spaced far away from the first mounting initiating position P1.

The first fitting control groove 33 is a groove along which the first lever engagement shaft portion 12 which lies in the first mounting initiating position P1 slides when the fitting control lever 30 mounted on the first connector housing 10 is pulled out of the first connector housing 10 along the first inclination angle θ1 as indicated by an arrow X3 in FIG. 7.

The second boss introduction grooves 34 are formed individually on outer surfaces of the pair of lever main bodied 31 so as to extend along a straight line m3 as shown in FIG. 4. The straight line m3 is a straight line which extends along the direction in which both the connector housings are fitted together (the direction indicated by the arrow Z2 in FIG. 1). Additionally, the straight line m3 is a straight line which is superposed on the straight line m2 shown in FIG. 6. Namely, the second boss introduction grooves 34 are formed on the outer surfaces of the pair of lever main bodies 31 along the direction in which both the connector housings are fitted together (the direction indicated by the arrow Z2 in FIG. 1).

The second boss introduction grooves 34 guide the second lever engagement shaft portions 22 to a second mounting initiating position P2 as shown in FIG. 8 when the first connector housing 10 on which the fitting control lever 30 is mounted with the first lever engagement shaft portions 12 lying in the first mounting initiating position P1 and the second connector housing 20 are registered with their fitting initiating position. This second mounting initiating position P2 is a position which coincides with a terminating end of the second boss introduction grooves 34 and where the second lever engagement shaft portions 22 are stopped.

As shown in FIG. 4, the second fitting control grooves 35 are formed individually on the outer surfaces of the pair of lever main bodies 31 so as to extend along a straight line m5. Additionally, the second fitting control grooves 35 are formed so as to communicate with the terminating ends of the second boss introduction grooves 34.

The straight line m5 is a straight line which extends at the first inclination angle θ1 (the inclination angle of the guide ribs 23) with respective to the direction in which both the connector housings are fitted together (the direction indicated by the arrow Z2 in FIG. 1).

The second fitting control groove 35 is a groove along which the second lever engagement shaft portion 22 which lies in the second mounting initiating position P2 slides when the fitting control lever 30 which is mounted on the first connector housing 10 with the second lever engagement shaft portion 22 situated in the second mounting initiating position P2 is pulled out of the second connector housing 20 at the first inclination angle θ1 as indicated by an arrow X4 in FIG. 8.

As shown in FIG. 4, the temporary securing piece 36 includes an elastic piece 36a which extends from an upper edge side to a lower edge side of the lever main body 31 along the direction in which both the connector housings are fitted together and a securing elongated projection 36b which is formed so as to protrudes outwards from a lower edge of the elastic piece 36a. The securing elongated projection 36b is a rib-like projection which extends at the first inclination angle θ1 at which the guide rib 23 on the second connector housing 20 extends.

As shown in FIG. 8, the temporary securing piece 36 is brought into engagement with the guide rib 23 when the second lever engagement shaft portion 22 comes to be situated in the second mounting initiating position P2 to thereby restrain the fitting control lever 30 from moving along the direction in which both the connector housings are fitted together so as to be disengaged from the second connector housing 20.

As shown in FIG. 4, the positioning portion 37 includes a pair of projecting pieces 37a, 37b which project in a length direction of the lever main body 31 in upper and lower positions of a front end of the lever main body 31.

As shown in FIG. 7, the positioning portion 37 is brought into abutment with the lever temporary securing portion 14 in such a way that the pair of projecting pieces 37a, 37b hold the lever temporary securing portion 14 therebetween from thereabove and therebelow so as to position the first connector housing 10 at a front end portion of the lever main body 31 when the first lever engagement shaft portion 12 which fits in the first boss introduction groove 32 reaches the first mounting initiating position P1.

In the lever-type connector 1 of this embodiment, by pulling out the fitting control lever 30 from both the connector housings in such a state that the first connector housing 10 and the second connector housing 20 are registered with their fitting initiating position with the first lever engagement shaft portions 12 lying in the first mounting initiating position P1 and the second lever engagement shaft portions 22 lying in the second mounting initiating position P2 as shown in FIG. 8, the connector housings are fitted and connected to each other.

Next, an operating procedure of fitting and connecting together the connector housings of the lever-type connector 1 of this embodiment and the working effect thereof will be described based on FIGS. 7 to 10.

In the case of this embodiment, firstly, the fitting control lever 30 is mounted on the first connector housing 10 so that the pair of first lever engagement shaft portions 12 of the first connector housing 10 fit in the pair of boss introduction grooves 32 on the fitting control lever 30. Then, the fitting control lever 30 is fixed to the first connector housing 10 in a temporarily secured state in which the first lever engagement shaft portions 12 reach the first mounting initiating position P1 as shown in FIG. 7.

Following this, the first connector housing 10 to which the fitting control lever 30 is temporarily secured is inserted into the outer angularly tubular wall portion 21 of the second connector housing 20 along the direction in which both the connector housings are fitted together as indicated by an arrow Z2 in FIG. 7. Then, the first connector housing 10 and the second connector housing 20 are registered with their fitting initiating position as shown in FIG. 8.

With the first connector housing 10 and the second connector housing 20 registered with their fitting initiating position, as shown in FIG. 8, the pair of second lever engagement shaft portions 22 of the second connector housing 20 fit in the second boss introduction groves 34 on the fitting control lever 30 and reach the second mounting initiating position P2 on the second boss introduction grooves 34.

Additionally, with the first connector housing 10 and the second connector housing 20 registered with their fitting initiating position, the temporary securing pieces 36 which are provided on the fitting control lever 30 are brought into engagement with the corresponding guide ribs 23 on the second connector housing 20. Then, by engagement of the temporary securing pieces 36 with the guide ribs 23, the fitting control lever 30 is restrained from moving along the direction in which both the connector housings are fitted together to thereby be disengaged from the second connector housing 20. Thus, as shown in FIG. 8, the fitting control lever 30 and the first connector housing 10 are temporarily secured to the second housing 20.

Next, the fitting control lever 30 is pulled out in a direction indicated by an arrow X4 shown in FIG. 8 from the first connector housing 10 and the second connector housing 20 which are registered with their fitting initiating position. Then, by pulling out the fitting control lever 30 in this way, as shown in FIG. 9, the first lever engagement shaft portions 12 which are situated in the first mounting initiating position P1 slide over the first fitting control grooves 33 which are formed so as to communicate with the first boss introduction grooves 32. Additionally, the second lever engagement shaft portions 22 which are situated in the second mounting initiating position P2 slide over the second fitting control grooves 35 which are formed so as to communicate with the second boss introduction grooves 34.

The respective pairs of fitting control grooves are formed so as to extend while being inclined at such inclination angles that the first fitting control grooves 33 on the fitting control lever 30 intersect the second fitting control grooves 35 at the end portions which are spaced far away from the first mounting initiating position P1. Therefore, as the fitting control lever 30 is pulled out progressively, the first lever engagement shaft portions 12 on the first fitting control grooves 33 are moved towards the second lever engagement shaft portions 22 on the second fitting control grooves 35, whereby both the connector housings are getting fitted deeply together.

Then, when the fitting control lever 30 is pulled out of both the connector housings as shown in FIG. 10, the connector housings are fitted together completely and at the same time, the fitting control lever 30 is disengaged from both the connector housings. In addition, when both the connector housings are fitted and connected together completely, the locking securing portion 13 of the first connector housing 10 is brought into engagement with the securement ensuring portion 24 of the second connector housing 20, whereby both the connector housings are locked in the connected state.

Namely, the lever-type connector 1 of the first embodiment which has been described heretofore has the configuration in which the connector housings are fitted together deeply in the progressive fashion as the fitting control lever 30 is pulled out. Then, when the connector housings are fitted and connected together completely, the fitting control lever 30 is pulled out of the connector housings and is disengaged from both the connector housings. Because of this, the weight of the fitting control lever 30 is not applied to the connector housings when the connector 1 is in use, thereby making it possible to realize a reduction in weight of the connector 1 when in use.

In addition, the fitting control lever 30 can be used to build up another lever-type connector. Because of this, the fitting control lever 30 can be excluded from a set of parts for a normal lever-type connector so that only the first connector housing 10 and the second connector housing 20 have to be prepared therefor, thereby making it possible to realize a reduction in the number of parts involved.

Further, in the case of the lever-type connector 1 of the first embodiment, as shown in FIGS. 4 and 6, the first boss introduction grooves 32 and the second boss introduction grooves 34 on the fitting control lever 30 are formed on front and rear sides of the lever main bodies 31 so as to be aligned with each other in the direction in which both the connector housings are fitted together. Therefore, the first boss introduction grooves 32 and the second boss introduction grooves 34 can be designed to be disposed the same spacing distance from the same reference plane, thereby making it possible to facilitate the disposition design of the first boss introduction grooves 32 and the second boss introduction grooves 34.

In addition, in the case of the lever-type connector 1 of the first embodiment, when the fitting control lever 30 is mounted on the first connector housing 10, the first lever engagement shaft portions 12 of the first connector housing 10 are positioned in the first mounting initiating position P1 by the first boss introduction grooves 32. Further, the positioning portions 37 of the fitting control lever 30 are brought into abutment with the lever temporary securing portions 14 of the first connector housing 10, whereby the fitting control lever 30 is temporarily fixed to the first connector housing 10.

In other words, since the fitting control lever 30 mounted on the first connector housing 10 is positioned at two locations such as the first boss introduction grooves 32 and the positioning portions 37, it is possible to ensure a stable positioning of the fitting control lever 30 in which the loosening of the fitting control lever 30 is made difficult to occur. Because of this, when the first connector housing 10 and the second connector housing 20 are registered with their fitting initiating position, the fitting control lever 30 can be prevented from being displaced inadvertently, thereby making it possible to facilitate the registration of the first connector housing 10 and the second connector housing 20 with their fitting initiating position.

Consequently, the fitting and connecting of the first connector housing 10 and the second connector housing 20 can be facilitated.

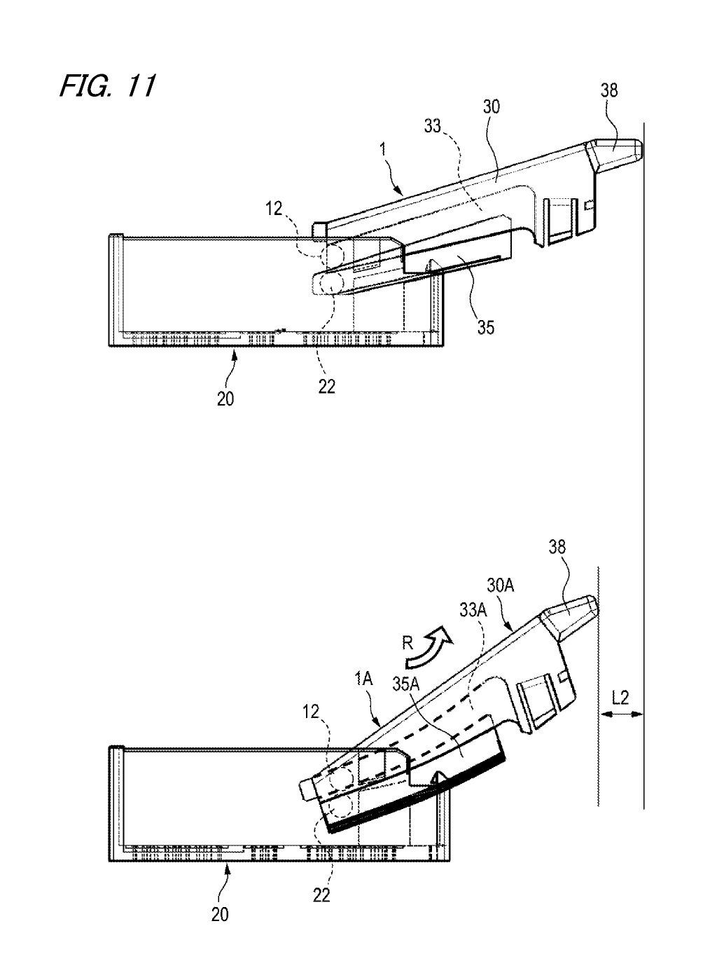

FIG. 11 is a side view showing a comparison between a lever-type connector 1A according to a second embodiment of the invention and the lever-type connector 1 according to the first embodiment.

A fitting control lever 30A of the lever-type connector 1A according to the second embodiment is such that the fitting control grooves 33 and the second fitting control grooves 35 of the fitting control lever 30 of the first embodiment are changed to first fitting control grooves 33A and second fitting control grooves 35A, respectively. The first fitting control grooves 33A and the second fitting control grooves 35A of the second embodiment have such curved groove configurations that a moving locus of the fitting control lever 30A that is formed when the fitting control lever 30A is pulled out is made into a curve as indicated by an arrow R in FIG. 11.

In the case of the fitting control lever 30A of the second embodiment, when the fitting control lever 30A is pulled out from both the connector housings, a displacement of the fitting control lever 30A in a direction in which both the connector housings are fitted together is shortened by a distance L2 shown in FIG. 11 compared with the case of the first embodiment in which the moving locus of the fitting control lever 30 becomes rectilinear. Because of this, a working space necessary to pull out the fitting control lever 30A can be reduced, thereby making it possible to realize a highly compact mounting of the lever-type connector.

It should be noted that the invention is not limited to the embodiments that have been described heretofore and hence can be modified or improved as required. Additionally, the materials, shapes, dimensions, numbers and arrangements of the constituent elements in the respective embodiments are arbitrary and are not limited thereto, provided that the invention can be attained.

For example, while the single locking securing portion 13 and the single securement ensuring portion 24 are provided in the embodiments described, a configuration may be adopted in which locking securing portions 13 and securement ensuring portions 24 are each provided in a plurality of locations so that both connector housings are locked in a connected state by a plurality of securing portions.

It is apparent that various modifications can be made in the invention within a scope not deviating from the gist of the invention.

The present invention is useful for providing a lever-type connector which can realize a reduction in production cost and weight in use by reducing the number of constituent parts involved.

What is claimed is:

1. A lever-type connector comprising:
a first connector housing:
a second connector housing which is fitted and connected to the first connector housing; and
a fitting control lever which is mounted on the first connector housing as a fitting assist member; wherein
the first connector housing comprises:
a housing main body including a plurality of terminal insertion holes; and
a pair of first lever engagement shaft portions which are provided individually on a pair of outer side walls of the housing main body so as to project therefrom; wherein
the second connector housing comprises:
an outer angularly tubular wall portion which fits on an outer circumference of the first connector housing;
a pair of second lever engagement shaft portions that are provided individually on a pair of inner side surfaces of the outer angularly tubular wall portion which oppositely face the pair of outer side walls of the first connector housing so as to project therefrom and which are positioned a predetermined spacing distance opposite to the first lever engagement shaft portions in a direction in which both the connector housings are fitted together when the first connector housing and the second connector housing are registered with their fitting initiating position; and
guide ribs which are provided individually on the pair of inner side surfaces so as to extend at a first inclination angle which is set to a predetermined inclination angle with respect to the direction in which both the connector housings are fitted together; wherein
the fitting control lever comprises:
a pair of lever main bodies which are disposed opposite to each other so as to be inserted into gaps defined between the pair of outer side walls of the first connector housing and the pair of inner surfaces of the outer angularly tubular wall portion;
first boss introduction grooves that are formed individually on inner surfaces of the pair of main bodies along the direction in which both the connector housings are fitted together and which guide the first lever engagement shaft portions to a first mounting initiating position when the pair of lever main bodies are placed on the pair of outer side walls;
first fitting control grooves along which the first lever engagement shaft portions which are situated in the first mounting initiating position slide when the fitting control lever which is mounted on the first connector housing is pulled out of the first connector housing at the first inclination angle and which are formed so as to communicate with the first boss introduction grooves at a second inclination angle at which portions of the first fitting control grooves which are far away from the first mounting initiating position intersect extensions of the guide ribs which extend at the first inclination angle;
second boss introduction grooves that are formed individually on outer surfaces of the pair of lever main bodies along the direction in which both the connector housings are fitted together and which guide the second lever engagement shaft portions to a second mounting initiating position when the first connector housing on which the fitting control lever is mounted in such a state that the first lever engagement shaft portions are situated in the first mounting initiating position and the second connector housing are registered with their fitting initiating position; and
second fitting control grooves along which the second lever engagement shaft portions which are situated in the second mounting initiating position slide when the fitting control lever which is mounted in such a state that the second lever engagement shaft portions are situated in the second mounting initiating position is pulled out of the second connector housing at the first inclination angle and which are formed so as to communicate with the second boss introduction grooves at the first inclination angle; and wherein
both the connector housings are fitted and connected together, by pulling out the fitting control lever from both the connector housings in such a state that the first connector housing and the second connector housing are registered with their fitting initiating position, the first lever engagement shaft portions are situated in the first mounting initiating position, and the second lever engagement shaft portions are situated in the second mounting initiating position.

2. The lever-type connector according to claim 1, wherein
the fitting control lever is adapted to reduce operation forces with which the first connector housing and the second connector housing are fitted together and are released from such a fitted state,
the first connector housing further comprises a locking securing portion that is provided on a side surface of the housing main body and which is brought into engagement with the second connector housing when the first connector housing and the second connector housing are fitted and connected together completely to thereby lock both the connector housings in a connected state,
the second connector housing further comprises a securement ensuring portion which is brought into engagement with the locking securing portion when the first connector housing and the second connector housings are fitted and connected together completely to thereby lock both the connector housings in a connected state, and
the fitting control lever further comprises temporary securing pieces which are brought into engagement with the guide ribs when the second lever engagement shaft portions are situated in the second mounting initiating position to thereby restrain the fitting control lever from moving along the direction in which both the connector housings are fitted together to be disengaged from the second connector housing.

3. The lever-type connector according to claim 1, wherein
the first lever engagement shaft portions and the second lever engagement shaft portions are disposed so as to be aligned with each other in a direction which is at right angles to the direction in which both the connector housings are fitted together.

4. The lever-type connector according to claim 1, wherein
the first connector housing comprises temporary lever securing portions which are positions away from the first lever engagement shaft portions in the direction which is at right angles to the direction in which both the connector housings are fitted together, and wherein
the fitting control lever comprises positioning portions which are brought into engagement with the temporary lever securing portions when the first lever engagement shaft portions which fit in the first boss introduction grooves reach the first mounting initiating position.

5. The lever-type connector according to claim 1, wherein
the first fitting control grooves and the second fitting control grooves are formed into a curvilinear configuration so that a moving locus of the fitting control lever produced when the fitting control lever is pulled out becomes curvilinear.
